(19) United States
(12) Patent Application Publication
(10) Pub. No.: US 2017/0046456 A1
(43) Pub. Date: Feb. 16, 2017

(54) Electric Power Substation Reliability Analysis

(71) Applicant: ABB Technology AG, Zurich (CH)

(72) Inventors: Krassimir Kutlev, Cary, NC (US); Bo X. Malmros, Vasteras (SE); Goran Arvidsson, Orebro (SE); Jose Ignacio Garrido, Baden (CH)

(21) Appl. No.: 14/823,475

(22) Filed: Aug. 11, 2015

(51) Int. Cl. G06F 17/50; G06F 17/18

(52) U.S. Cl. CPC G06F 17/5009; G06F 17/18

(57) ABSTRACT

Methods for managing an electrical power substation based on enhanced estimation of the substation's reliability, using statistical reliability data for substation components. An example method comprises obtaining statistical reliability data for each of a plurality of components in the electrical power substation, obtaining component condition assessment data for each of one or more of the plurality of components in the electrical power substation, and adjusting the statistical reliability data for each of one or more of the plurality of components for which component condition assessment data has been obtained, based on the corresponding condition assessment data. A substation reliability model is then computed, based on at least the adjusted statistical reliability data.

### TECHNICAL FIELD

The present disclosure is related to electric power systems and is more particularly related to managing an electrical power substation based on enhanced estimation of the substation's reliability.

### BACKGROUND

When an electrical power substation approaches 25-30 years of service, its owner has to make a decision regarding what steps, if any, should be taken to extend the substation's operating life. In general, this is done by evaluating the current condition of the substation's components and determining whether replacement, repair, retrofit, and/or maintenance of all or some of the substation's critical components should be undertaken. The decision criteria generally takes into account the costs of each option.

The process flow of FIG. 1 illustrates a conventional process for managing a substation's lifecycle. As shown at block 110, at some point it is recognized that the substation is aging. This may be triggered by the reaching of a certain age for the substation and/or for one or more of its components, or by a simple schedule for evaluating the substation. Alternatively, this may be triggered by a failure or pattern of failure in the substation. In any case, this triggering of an evaluation is followed by an assessment of each component of the substation, including, for example, transformers, breakers, protection devices, disconnects, etc. Typically, checklists specific to each component are used to evaluate the condition of the component and to thereby assign it a “score,” e.g., ranging from zero to one hundred.

As shown at block 130, the component condition data is then used to generate recommendations as to the next steps. The generation of recommendations may be based on all or a limited number of the components, such as those with the very worst condition scores, or those which are deemed most important to the substation's operation, e.g., according to a predetermined “importance” ranking of the components.

Options for proceeding include the repair or replacement of some or all of the substation components, as shown at block 140. In some cases, the component condition assessment may be inconclusive, indicating that additional diagnostics of one or more components should be performed, e.g., where a visual assessment of the component's condition does not yield useful information. This is shown at block 150, and may include, for example, taking one or more components out of service to perform the diagnostic testing. In this case, the recommendation generation process shown at block 130 should be repeated, based on the better information obtained from the additional diagnostics. Sometimes the visual assessment is not enough and additional components diagnostics can be recommended. In this case, the components is taken out of service for the diagnostic. Such approach is necessary to better evaluate the current component condition and recommend a solution: maintenance, repair/replacement, retrofit.

Another option for proceeding is to perform maintenance for some or all of the substation components, as shown at block 160. This option, however, may require the selection from one of several possible maintenance strategies, as shown at block 165. This selection may be based on the condition assessment data for the substation components, for example, but may also be based on owner preferences, available resources, etc.

Conventionally, the options for the maintenance strategy include a reliability-centered maintenance (RCM) strategy, which selects components and timing for maintenance activities based on the condition of the components and each component's predetermined importance for substation reliability. A somewhat simpler strategy is a condition-based maintenance (CBM) strategy, whereby component maintenance is performed based on condition indicators that show that a component is going to fail or that the component's performance is deteriorating. An even simpler strategy is a time-based maintenance (TBM), in which component maintenance is dictated by a schedule, which may be component-specific.

Still another option is substation retrofit, which may be preferred when many or most of the components are aging and may need repair or replacement. In this case, the whole substation may be impacted.

### SUMMARY

One problem with conventional approaches to substation management is that they generally consider the initial investment cost, but do not take into full account the impact of various maintenance activities on overall substation reliability, or of the true additional costs for the life-cycle extension of the substation. Furthermore, while conventional approaches are based on a condition assessment of the substation components, they do not exploit the rich statistical reliability data that is increasingly available. Embodiments of the presently disclosed invention include improved methods for managing an electrical power substation that address one or more of these problems with conventional approaches.

An example method includes obtaining statistical reliability data for each of a plurality of components in the electrical power substation, obtaining component condition assessment data for each of one or more of the plurality of components in the electrical power substation, and adjusting the statistical reliability data for each of one or more of the plurality of components for which component condition assessment data has been obtained, based on the corresponding condition assessment data. The method further includes computing a substation reliability model, based on at least the adjusted statistical reliability data.

In some embodiments, obtaining the statistical reliability data comprises, for at least one of the plurality of components, using a component age or a component manufacture data to retrieve statistical reliability data that corresponds to the component age or component manufacture date. In some embodiments, service time data is obtained for each of one or more of the plurality of components, and the computing of the substation reliability model is further based on the obtained service time data.

In some embodiments, a component importance value is calculated for each of one or more of the plurality of components, based on the corresponding component's contribution to substation reliability as reflected in the computed substation reliability model. In this way, the computed substation reliability model better reflects the current level of substation reliability. In some of these embodiments, the calculating of the component importance value for each of one or more of the plurality of components is based on the respective component's effect on one or more of: power outage frequency; power outage duration; expected energy not supplied; and cost of power interruption. In some embodiments, calculating the component importance value for each of one or more of the plurality of components takes into account the respective component's effect on one or more particular load feeders.

The methods summarized above may further include, in some embodiments, computing a maintenance cost for the substation, based on the computed substation reliability model. The methods may still further include selecting from a plurality of maintenance strategies, where computing the maintenance cost for the substation is further based on the selected maintenance strategy. In some embodiments, a lifecycle operating cost for the substation is calculated, based on at least the computed maintenance cost.

Any of the methods summarized above may include, in some embodiments, identifying two or more technical modification plans for the substation, the technical modification plans each comprising a refurbishment, retrofit, and replacement, for one or more of the plurality of components, and recalculating reliability data for each component following the impact of the refurbishment, retrofit, and replacement action on their failure mode. An alternative substation reliability model is then computed for each of the two or more technical modification plans, based on the respective technical modification plan and further based on at least the adjusted statistical reliability data, and a respective alternative lifecycle operating cost for the substation is then computed for each of the two or more technical modification plans, based on the corresponding alternative substation reliability model. In some embodiments, computing the alternative substation reliability models comprises adjusting reliability data for each of the replaced and/or refurbished components.

Variations of the above-summarized methods are described in the detailed description that follows, as are apparatuses configured to carry out any of one or more of these methods.

### BRIEF DESCRIPTION OF THE FIGURES

FIG. 1 illustrates a conventional process flow for managing an aging electrical power substation.

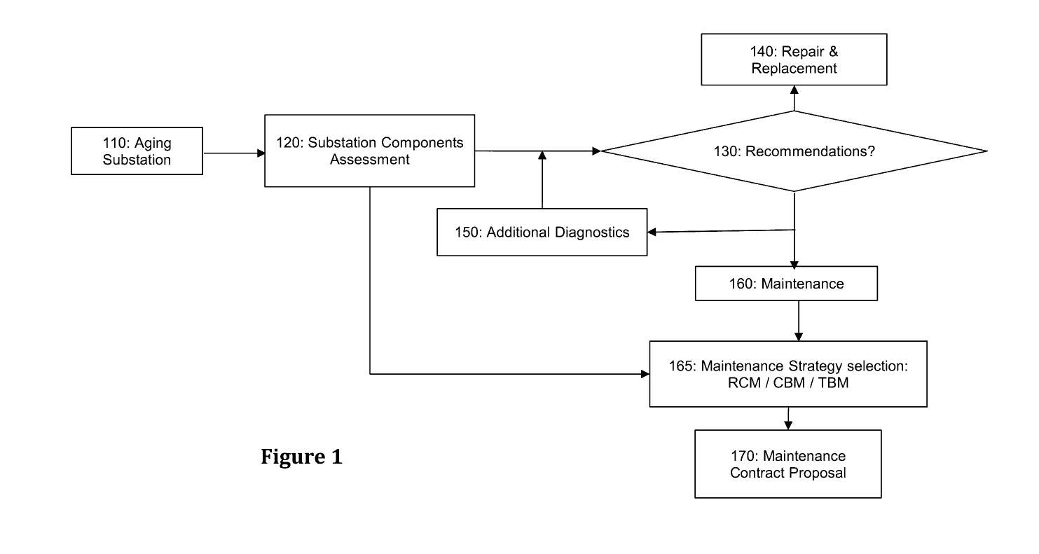

FIG. 2 illustrates an overview of a substation assessment and investment decision process.

FIG. 3 is a process flow diagram illustrating the adjustment of component reliability data and the computing of a substation reliability model, based on the adjusted reliability data.

FIG. 4 shows the building of a reliability model for a substation alternative, based on a technical modification solution.

FIG. 5 is a process flow diagram illustrating an example method for selecting an optimal substation life extension solution.

FIG. 6 is a diagram of an illustrative computing environment and an illustrative system for substation reliability evaluation and/or life extension solution evaluation.

FIG. 7 is a diagram of an illustrative networked computing environment with which the illustrative system of FIG. 6 may be employed.

### DETAILED DESCRIPTION

In the claims and discussion that follows, terms such as “first”, “second”, and the like, are used to differentiate between several similar elements, regions, sections, etc., and are not intended to imply a particular order or priority unless the context clearly indicates otherwise. Furthermore, as used herein, the terms “having”, “containing”, “including”, “comprising” and the like are open-ended terms that indicate the presence of stated elements or features but that do not preclude additional elements or features. The articles “a”, “an” and “the” are intended to include the plural as well as the singular, unless the context clearly indicates otherwise. Like terms refer to like elements throughout the description.

As noted above, at some point in a substation's lifecycle, one option is substation retrofit, which may be preferred when many or most of the components are aging and may need repair or replacement. At this point, the owner has to decide what steps to take to extend the substation's operating life. In this case, the whole substation may be impacted.

One problem with conventional approaches to substation management in general and with refurbishing/retrofit decision making processes more specifically is that they generally consider the initial investment cost, but do not take into full account the impact of various maintenance activities on overall substation reliability, or of the true additional costs for the life-cycle extension of the substation. Furthermore, while conventional approaches are based on a condition assessment of the substation components, they do not exploit the rich statistical reliability data that is increasingly available.

Described herein is a unique approach in evaluating the reliability of substation components by using their condition assessments in combination with reliability statistics obtained from open sources, such as the International Council on Large Electric Systems (CIGRE), the Institute for Electrical and Electronics Engineering (IEEE), the Canadian Electricity Association (CEA), etc. An algorithm is used to re-evaluate reliability of each component, e.g., its expected failure rate, by using its condition assessment. For example, as a result of the condition assessment, each component is ranked, e.g., from 0 to 100, depending of its current condition. Depending on the component age, a point estimation, lower limit and upper limit is assigned for its failure frequency, using the statistical reliability data. The actual failure rate is then re-calculated for each component by using the component condition assessment ranking within the statistical upper and lower limits. Combining these recalculated failure rates with a model for the substation allows the building and benchmarking of a reliability model that better reflects the current substation condition.

As discussed in further detail below, the improved modeling of the substation's reliability can be used to generate a reliability centered maintenance strategy that considers equipment importance based on each component's real contribution to substation reliability and economics, rather than on assumptions and suggestions of each component's relative importance, as is done currently. Various technical and economic criteria can be used for this component importance evaluation, depending on customer preferences, such as outage frequency, outage duration, expected energy not supplied (EENS), cost of power interruption, etc. The importance of each component can be calculated, taking into account the entire substation. Alternatively, this can be done only for particular load feeders supplying specific processes and loads. As an example, each components may be ranked from 0 to 100, depending on its importance and according to the selected criteria, with the resulting rank reflecting an importance that takes into account the component's condition, statistical reliability data for the component, and its operation within the substation.

Given the improved reliability modeling described above, it is then possible to better calculate and compare the operation and maintenance costs for several different alternatives for refurbishing and/or retrofitting the substation, based on a proposed maintenance strategy (TBM/ CBM/RCM). The impact of the maintenance strategy in the substation lifecycle cost is calculated in order to allow a more accurate cost-based evaluation of different life-extension alternatives for the substation. The maintenance scope that can be accounted for in computations of the costs of operation and maintenance of the substation may include the costs for inspections as well as preventive and predictive maintenance actions.

Thus, in order to optimize operation and maintenance cost during the substation life, not only is the selection of the maintenance strategy considered, but the operational approach to perform the maintenance activities is taken into account. This is done by considering, in the computation of costs, the durations of maintenance outages, the resources allocated, in consideration of the outage durations, and the numbers and sizes of working teams on site to perform the maintenance tasks. Considering all these variables, the methodology outlined above enables the user to optimize maintenance investment and therefore to reduce the lifecycle cost for the substation.

Refurbishing and/or retrofitting an aging substation can involve the evaluation of several possible technical modification solutions, where the technical solutions vary with respect to which components are repaired, replaced, or refurbished. The techniques herein provide for easier selection of technical modification solutions, since the importance of each component is more reliably established. Reliability analysis of the existing substation, specific customer requirements, and other design comparison criteria are used to identify potential technical solutions for substation life extension.

The reliability-centric lifecycle cost evaluation approach discussed above is then used to evaluate and compare the proposed technical solutions. As already noted, the reliability statistics and failure mode data from open sources is used to better model each of the proposed alternatives. By using statistical data for the components' reliability and failure modes from open sources, together with the components' ages, the reliability for each component can be assessed, depending on the proposed action for life extension, e.g., operation mechanism replacement, refurbishment of interrupter, interrupter replacement, bushing replacement, etc. Thus, the reliability and economics for each of the proposed technical solutions can be modeled and evaluated more precisely. This allows the selection of an optimal technical solution, among the considered alternatives, considering the investment cost, operation and maintenance cost, cost of power interruption, total lifecycle cost and the differences in the lifecycle extension durations for the proposed alternatives. The economics of each solution can be evaluated, e.g., in terms of benefits versus cost, payback period, life cycle cost, net present value, etc.

In short, the techniques described here provide an overall methodology for selecting an optimal technical modification solution for substation life extension based on reliability and economics. The proposed methodology covers the entire process of substation services, starting with the initial steps of substation component condition assessment and proceeding through reliability evaluation for the existing substation, defining the customer operation and maintenance strategy, proposing different alternatives for substation life extension and finalizing the process with selecting an optimal life extension solution based on specific technical recommendations, reliability and economic criteria.

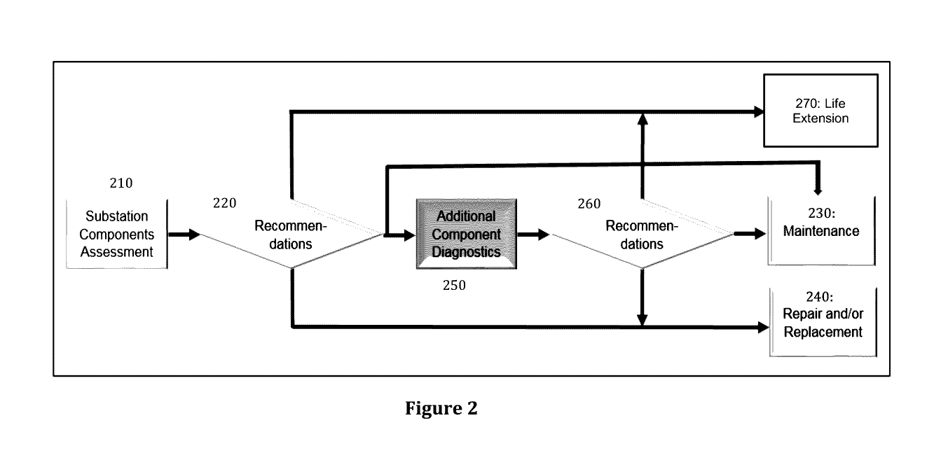

FIG. 2 illustrates an overview of a substation assessment and investment decision process according to some embodiments of the presently disclosed techniques. As seen at block 210, the illustrated process begins with a conventional condition assessment of the substation components. This assessment is followed by the generation of one or more recommendations, as shown at block 220, based on the condition assessment and, in some embodiments, the importance of each of the various components. These recommendations may include a maintenance program for specific components, as shown at block 230, or a program for repair and/or replacement of substation components, as shown at block 240. In some cases, additional component diagnostics may be performed for one or more components, as shown at block 250, in which case the recommendations generation is performed again, as shown at block 260. Once the substation has reached a certain age or when its overall condition is determined to be relatively poor, based on the component conditions, a life extension process may be recommended, as shown at block 270. As suggested above, this life extension process may include, in some embodiments, the generation and evaluation of several technical solutions for repair, refurbishment, and maintenance of the substation, based on the condition of the substation components and further based on statistical reliability data for the components.

A key feature of several embodiments of the processes disclosed herein is that statistical reliability data for the substation components is collected, and then the reliability data is adjusted, based on the component condition assessment. This adjusted component reliability data is then used to model the reliability of the overall substation.

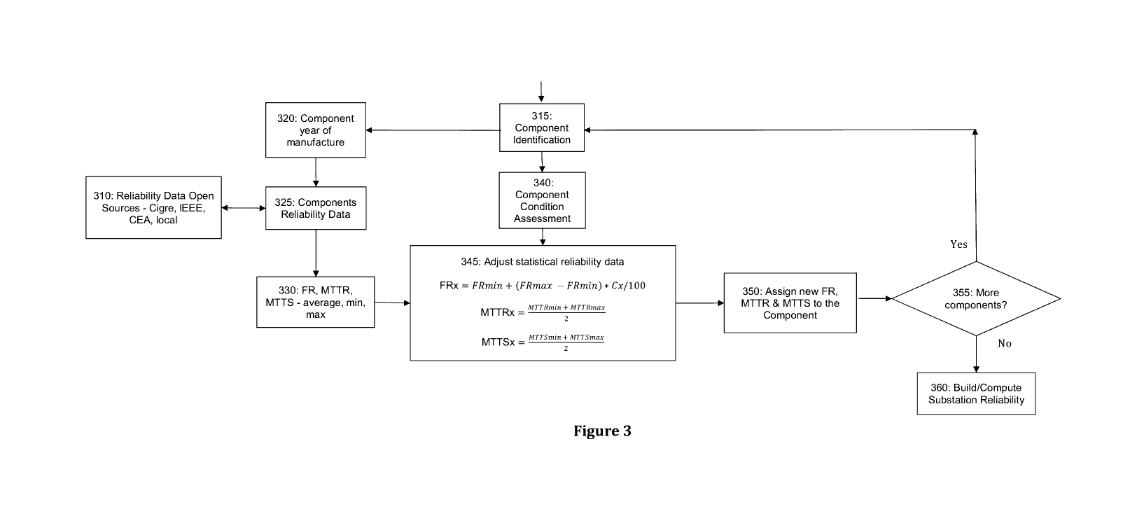

This process is illustrated in FIG. 3. As shown at block 310, statistical reliability data for each of several or all components in the electrical power substation is collected and maintained. This data may be collected by or using sources such as CIGRE, IEEE, or CEA databases, and/or locally developed reliability information databases, for example. This statistical reliability data may include failure rate (FR) statistics for each component, or similar or equivalent reliability metrics, including, for example, a mean failure rate and a standard deviation, and/or a minimum and maximum failure rate. Reliability statistics from CIGRE, for example, gives three different values for the component failure frequency—a point of estimation value together with lower and upper limits. The statistical reliability data may also include service-related information for each of one or more of the components, such as a mean-time-to-repair (MTTR) and/or a mean-time-to-switch (MTTS). Minimums/maximums and/or standard deviations for those metrics may also be included.

The use of this reliability data is shown at blocks 315-355 of FIG. 3. As shown at block 315, a particular substation component is identified. Statistical reliability data specific to that component is then retrieved, as shown at block 325. In some cases, a component year of manufacture may be retrieved, as shown at block 320, in which case the obtained reliability data may be filtered or selected using that additional information. Alternatively, or in addition, an age of the component or a time since the component was put into service and/or repaired may be retrieved, and used to select/filter the component-specific reliability data. As shown at block 330, the component-specific reliability data thus obtained includes failure rate (FR) statistics or similar/equivalent reliability metrics, and may further include servicing time data for the component, such as MTTR and/or MTTS.

As shown at block 340, a condition assessment is performed for the component. This may be done using conventional checklists and/or scoring techniques. In some embodiments, the overall condition of the component may be given a score ranging from zero to one hundred, based on the assessment, where zero reflects a very poor condition and one hundred reflects an extremely good condition for the component. Of course, other scoring ranges may be used.

As shown at block 345, the statistical reliability data for the component is adjusted, based on its condition assessment data. Generally, this is done by calculating a specific failure rate within a range indicated by the statistical reliability data, using a component condition score. As seen in the figure, this can be done, for example, by computing a component-specific failure rate (FRx) according to:

FRx=FRmin+(FRmax−FRmin)*Cx/100, (1)
where FRmin and FRmax are minimum and maximum failure rates for the component (age-adjusted, in some cases) and Cx is a condition score ranging from zero to one hundred. FRmin and Frmax may be obtained directly from the original statistical reliability data, in some embodiments. Alternatively, these may be computed from the statistical reliability data, e.g., by computing a range from a mean failure rate and a variance or standard deviation, e.g., according to:

FRmin=Fmean−α*α, and (2)

FRmax=Fmean+α*α, (3)
where Fmean is a component-specific mean failure rate for the component (age-adjusted, in some cases), a is the standard deviation of the failure rate for the component, and a is a predetermined constant.

As shown at block 350, the adjusted reliability data, e.g., the adjusted failure rate metric, is assigned to the component. Service-time related data, such as MTTR and/or MTTS may also be assigned to the component. It should be noted that these are typically not affected by the component condition score, although they may be in some embodiments.

If there are additional components to be assessed, as shown at block 355, then the component identification, condition assessment, and reliability statistics adjustment operations are repeated, as necessary. Note that while FIG. 3 illustrates this as a repetitive serial process, these operations can be performed in parallel for multiple components.

Finally, as shown at block 360, a substation reliability model is computed, using the adjusted statistical reliability data for the components. As discussed above, this reliability model better reflects the actual condition of the substation than a reliability model built from non-adjusted reliability data for the substation components.

In some embodiments, the computed reliability model is further based on the service time data, such as the MTTR and/or MTTS for substation components. This allows the evaluation of the substation reliability to reflect outage time and maintenance times, so that subsequent lifecycle cost evaluations are more comprehensive.

The techniques described above for adjusting component-specific statistical reliability data, based on the component condition, can be used not only to model and evaluate the reliability of an existing substation configuration, as illustrated in FIG. 3, but also to model and evaluate substation reliability for each of one or more repair/replace/refurbishment alternatives. The substation reliability models for these alternatives can be compared, to aid in the selection of an optimal technical modification solution for extending the life of the substation.

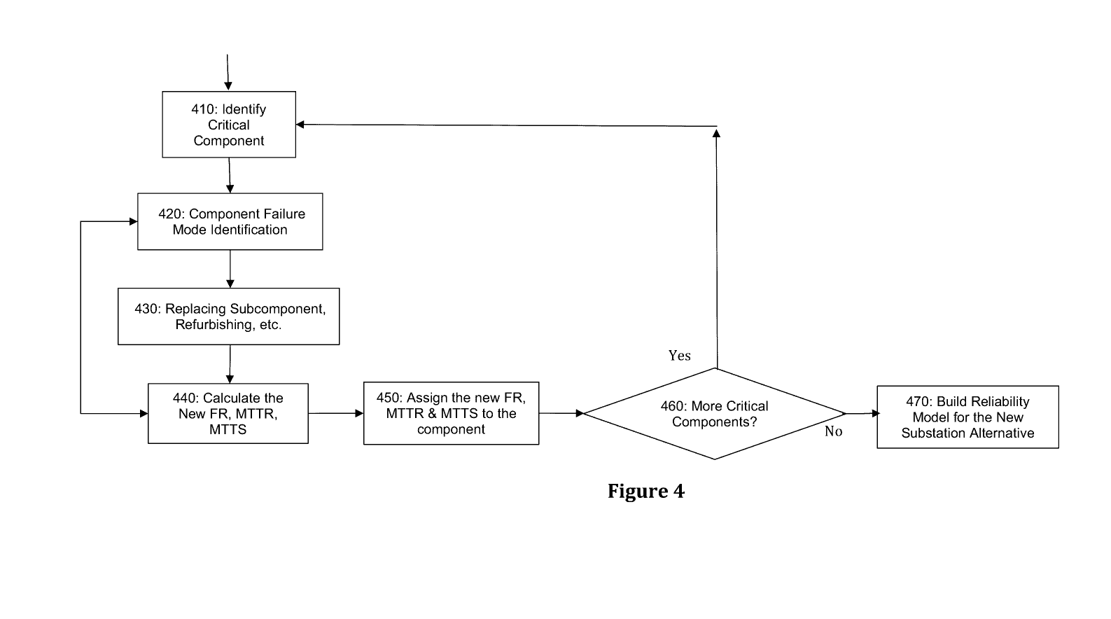

The building of a reliability model for one of these technical alternatives is shown in FIG. 4. As shown at block 410, the process begins with the identification of a critical component. This is done based on the reliability model for the current substation configuration, e.g., as computed according to the process shown in FIG. 3. This critical component may be, for example, the component that has the biggest impact on the overall substation reliability.

As shown at block 420, one or more component failure modes are identified for the component, in the context of the overall substation model. A decision as to whether to replace or refurbish the component or subcomponents thereof is made, as shown at block 430, and a new failure rate (or similar metric) is calculated for the component, based on whether and how it is replaced or refurbished, as shown at block 440, and assigned to the component, as shown at block 450.

If there are more critical components to evaluate, as shown at block 460, the identification and recalculating of reliability data for the components is repeated, as necessary. Finally, as shown at block 470, a reliability model is built/computed for the substation alternative. This reliability model incorporates the recalculated reliability data for the critical data, thus reflecting the individual repair/refurbishing decisions for the critical components, and also reflects the condition-adjusted statistical reliability data for the other components in the substation.

It will be appreciated that the process shown in FIG. 4 may be repeated for each of several technical solutions to extending the life of the substation, where the “critical components” for a given technical solution are those components that are refurbished and/or repaired under the technical solution. In this way, the reliability models for these technical solutions can be compared to one another, with each fully incorporating the available component reliability and condition data.

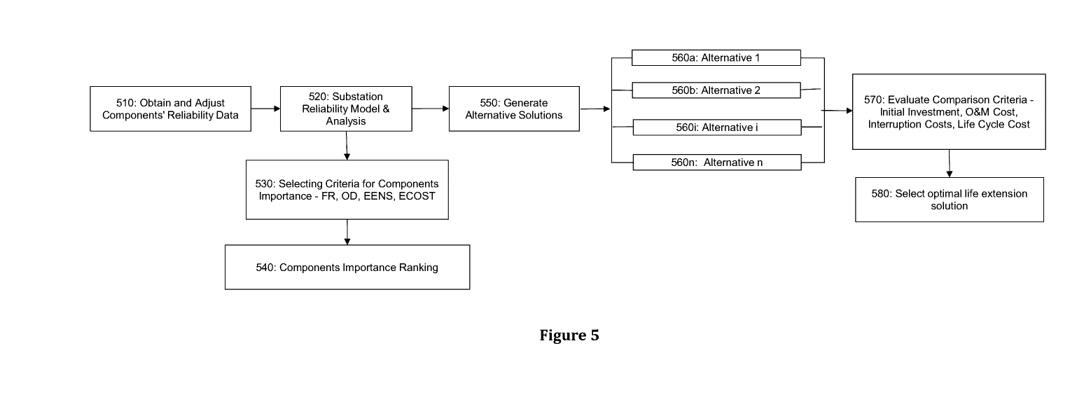

An example of this approach is shown in the process flow diagram of FIG. 5. As shown at block 510, statistical reliability data is obtained and adjusted, based on the condition of components. Then, the substation reliability for the existing substation configuration is model and analyzed, as shown at block 520. The operations shown in blocks 510 and 520 may be performed according to the technique illustrated in FIG. 3, for example.

Based on the reliability model for the existing substation configuration, some or all of the substation components may be ranked, based on their contributions to overall reliability. This is shown at block 540. Importantly, as shown at block 530, the ranking of the components may be based on one or more parameters related to the overall substation reliability, as well as one or more criteria that are based on owner/operator preferences. Example criteria that can be used for this ranking, depending on customer preferences, include: outage frequency (OF), outage duration (OD), expected energy not Supplied (EENS), and economic costs (ECOST).

Then, technical solutions involving different numbers or different ones of the most critical components, or involving different approaches taken to the same group of components, may be developed. This is shown at block 550 of FIG. 5. As a simple example, one technical solution may involve replacing and/or refurbishing only the three most important components, from the standpoint of overall reliability, while another involves the five most important components. More generally, various alternative solutions can include replacement and or repair of certain equipment to full substation overhaul.

A reliability model is built for each alternative, considering the different suggestions for equipment maintenance, repair, replacement, refurbishing and retrofit. This is shown at blocks 560a, 560b, 560i, and 560n. Components reliability statistics and failure mode from open sources are again used to build these alternative solutions. This allows a better modeling of the impact of different service approaches on components reliability.

As shown at block 570, all of the modeled alternatives are compared, based on their reliability. For example, load feeder outage frequencies and durations may be calculated for each alternative. The considered outage frequencies and durations may be split into two groups, in some embodiments: feeder outage frequencies and durations due to components failure, and f feeder outage frequencies and durations due to components maintenance. This split is necessary to evaluate the difference of the economic impact when the power outages are random, due to equipment fault or scheduled, due to equipment maintenance.

Other economic comparison criteria may be used to evaluate each of the proposed alternatives, such as: initial capital investment; operation and maintenance cost; cost of power interruption—this allows the reliability to be related to the substation economics; interest rates; and life durations for the proposed alternative—each of the proposed alternative can have different durations. Some or all of the criteria above are combined, in some embodiments, to calculate a lifecycle cost (LCC) for each alternative. By comparing the LCC, an optimal substation life extension solution can be selected, as shown at block 580. Note that each alternative solution can have different duration. To equally compare them, their costs should be evaluated over the same time period.

It should be appreciated that the components importance ranking and reliability analysis discussed above may also be used for designing and performing a reliability-centered maintenance (RCM) strategy that considers both the components' condition rankings and their importance rankings. The importance ranking here is based not on generic assumptions but on the components' real contributions to current substation reliability. Further, the calculations of lifecycle operation and maintenance costs for an existing substation configuration or for one of the technical solutions discussed above consider the customer maintenance strategy (TBM/ CBM/RCM), in addition to the components' conditions and importance.

Illustrative Computing Environment and System

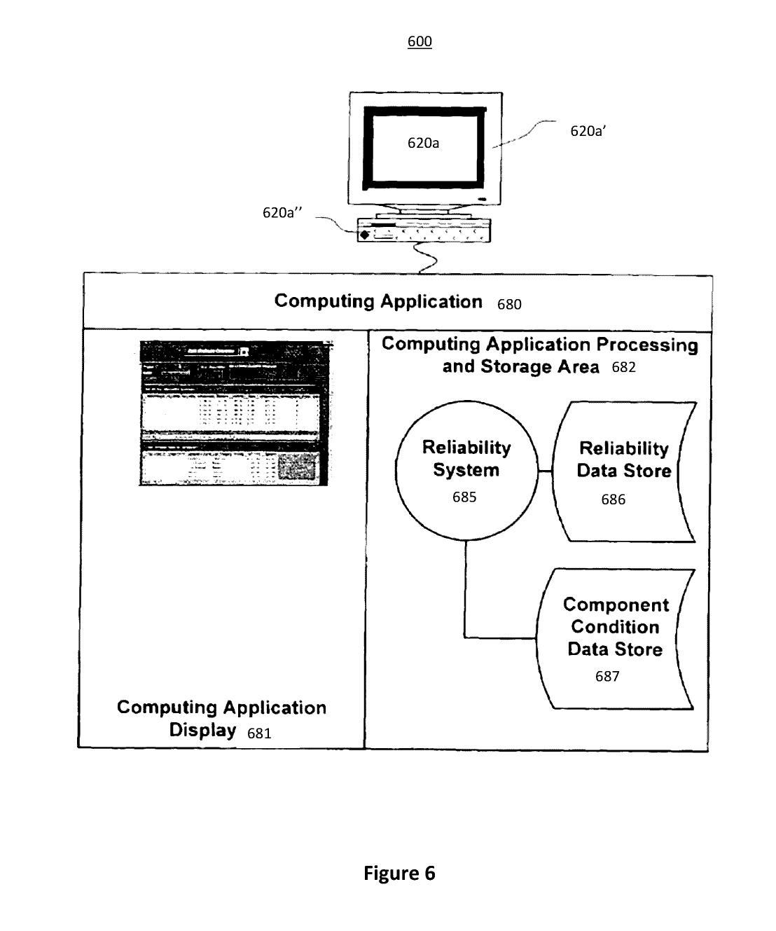

FIG. 6 illustrates details of an illustrative computing system 600 that includes computer 620a. Computer 620a includes display device 620a′ and interface and processing unit 620a″. Computer 620a executes computing application 680. As shown, computing application 680 includes a computing application processing and storage area 682 and a computing application display 681. Computing application processing and storage area 682 may include reliability system 685, reliability data 686, and component condition data 687. Reliability system 685 may implement systems and methods for electric power substation reliability assessment, according to any of the techniques described above, as well as for evaluating and comparing life extension solutions for the power substation. Computing application display 681 may include display content which may be used for substation reliability and substation life extension assessment. In operation, a user (not shown) may interface with computing application 680 through computer 620a. The user may navigate through computing application 680 to input, display, and generate data and information for substation reliability and substation life extension assessment.

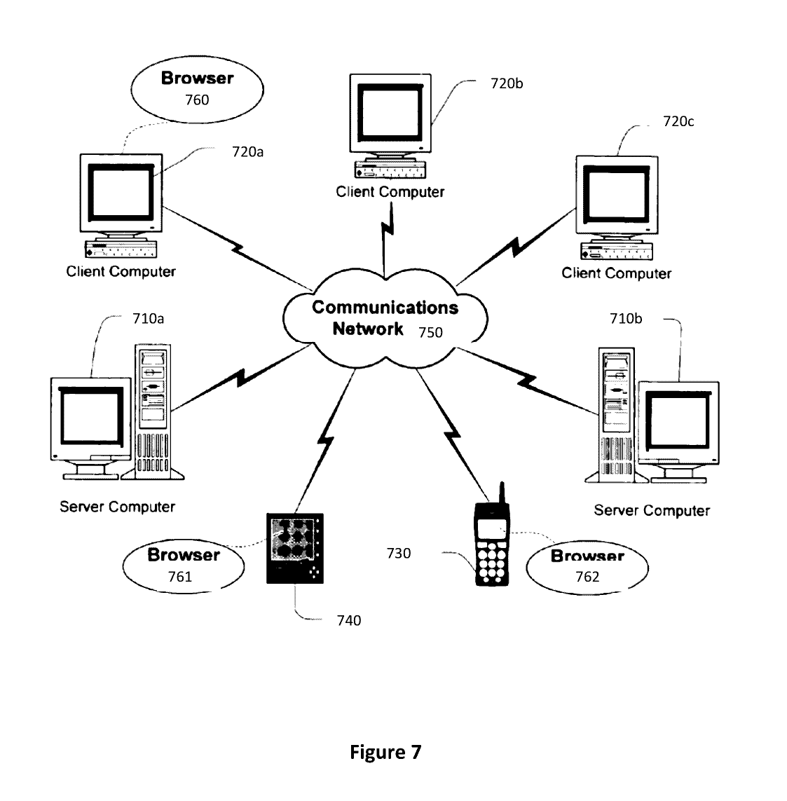

Computing application 680 may comprise program instructions that, when executed by computer 620a, cause computer 620a to carry out one or more of the methods described above, including those illustrated generally in FIGS. 2, 3, 4, and 5. Computer 620a, described above, can be deployed as part of a computer network. In general, the description for computers may apply to both server computers and client computers deployed in a network environment. FIG. 7 illustrates an exemplary networked computer environment having server computers in communication with client computers, in which systems and methods for substation reliability and substation life extension assessment may be implemented. As shown in FIG. 7, a number of server computers 710a, 710b, etc., are interconnected via a communications network 750 with a number of client computers 720a, 720b, 720c, etc., or other computing devices, such as, a mobile phone 730, and a personal digital assistant 740. Communication network 750 may be a wireless network, a fixed-wire network, a local area network (LAN), a wide area network (WAN), an intranet, an extranet, the Internet, or the like. In a network environment in which the communications network 750 is the Internet, for example, server computers 710 can be Web servers with which client computers 720 communicate via any of a number of known communication protocols, such as, hypertext transfer protocol (HTTP), wireless application protocol (WAP), and the like. Each client computer 720 can be equipped with a browser 760 to communicate with server computers 710. Similarly, personal digital assistant 740 can be equipped with a browser 761 and mobile phone 730 can be equipped with a browser 762 to display and communicate data and information.

In operation, the user may interact with computing application 680 to perform substation reliability and/or substation life extension assessment, as described above. The results of the assessments may be stored on server computers 710, client computers 720, or other client computing devices. The results may be communicated to users via client computing devices, client computers 720, or the like.

Thus, systems and methods for substation reliability and/or substation life extension assessment can be implemented and used in a computer network environment having client computing devices for accessing and interacting with the network and a server computer for interacting with client computers. The systems and methods can be implemented with a variety of network-based and standalone architectures, and thus should not be limited to the examples shown.

Computing application processing and storage area 682 may include a reliability data store 686 and a component condition data store 687. Reliability data store 686 may include information representative of the reliability of substation components, such as, for example, historical information on the failure rate of a particular type of circuit breaker, historical information on the failure rate of a particular type of power transformer, and the like. Such information may be available from various electric utility organizations, for example. The information may be in the form of a reference database (e.g., a library of component failure rates, aggregated and decomposed, national/regional average and utility-specific statistics, and the like). This component reliability data comprises statistics for different types of components. The information in reliability data store 686 may be used by reliability system 685 to determine a failure rate for a type of power network component, which may be adjusted according to the techniques described herein, using component condition data in component condition data store 687.

Component condition data store 687 may include information representative of the condition of a particular power network component, such as, for example, the age of a particular circuit breaker, the number of problems experienced with a particular circuit breaker, the number of months since the last preventive maintenance performed on a particular circuit breaker, and the like. Such information is described in more detail below. The information in component condition data store 687 can be used by reliability system 685 to adjust the failure rate determined from reliability data store 686.

Computing application processing and storage area 682 may include other data stores (not shown). For example, computing application processing and storage area 682 may include a data store that contains information representative of the interconnectivity of individual components of a power substation. Computing application processing and storage area 682 may further include a data store that contains information representative of individual component maintenance times, maintenance frequencies, failure times, and the like, such as, for example, a maintenance frequency (MF), a mean time to maintain (MTTM), a mean time to repair (MTTR), a mean time to switch (MTTS) for switching components, and the like, which may be used to determine a reliability assessment for a power substation.

While FIG. 6 shows only two databases in computing application processing and storage area 682, computing application processing and storage area 682 may include any number of databases. Further, the various data and information within computing application processing and storage area 682 may be distributed among various databases in any convenient fashion. Moreover, the data and information in computing application processing and storage area 682 may be stored in any convenient manner, such as, for example, in a multidimensional database, a relational database, tables, data structures, an analytical database, an operational database, a hybrid database, a text file, and the like.

The techniques and processes described above cover the entire process of managing a substation's life cycle from the initial approach of the substation components condition assessment to selecting an optimal substation life extension solution based on reliability and economics. Advantages provided by various embodiments disclosed herein include that the proposed methodology helps to generate a more precise reliability-centered maintenance strategy that considers not only the condition of substation components but also their real impact on overall substation reliability. It also gives the customer opportunity to select an optimal solution for substation life extension based on reliability and economics. A software platform developed to implement the methodology significantly decreases the time for the entire process, from starting with the substation components condition assessment to generating an optimal technical solution for aging substations

The business benefits of the disclosed techniques include that it is a complete approach to substation lifecycle management, allowing decisions for substation life extension to be mae based not only on assumptions and previous experience but on a more accurate modeling of the existing substation reliability level and the reliability and economic impacts of proposed substation life extension alternatives. The techniques facilitate a shorter time to select an optimal substation life extension solution, as well as the easy generation of reports for current substation assessment and the simplified proposing of maintenance contracts based on TBM/CBM/RCM. Key beneficiaries of this approach are substation owners having aging substations, who have to make decisions regarding how to proceed to extend the substations lives. The approaches detailed herein will help them to make decisions based on a more complete assessment of the reliability and economics, while considering the owners' specific requirements.

Detailed examples of several embodiments of the present invention have been described above. Of course, it should be understood that the present invention is not limited to any particular example given in the foregoing description, nor is it limited by the accompanying drawings. Instead, the present invention is limited only by the following claims and their legal equivalents.

1. A method for managing an electrical power substation, the method comprising:
obtaining statistical reliability data for each of a plurality of components in the electrical power substation;
obtaining component condition assessment data for each of one or more of the plurality of components in the electrical power substation;
adjusting the statistical reliability data for each of one or more of the plurality of components for which component condition assessment data has been obtained, based on the corresponding condition assessment data; and
computing a substation reliability model, based on at least the adjusted statistical reliability data.

2. The method of claim 1, wherein obtaining the statistical reliability data comprises, for at least one of the plurality of components, using a component age or a component manufacture data to retrieve statistical reliability data that corresponds to the component age or component manufacture date.

3. The method of claim 1, further comprising obtaining service time data for each of one or more of the plurality of components, wherein computing the substation reliability model is further based on the obtained service time data.

4. The method of claim 1, further comprising calculating a component importance value for each of one or more of the plurality of components, based on the corresponding component's contribution to substation reliability as reflected in the computed substation reliability.

5. The method of claim 4, wherein calculating the component importance value for each of one or more of the plurality of components is based on the respective component's effect on one or more of:
power outage frequency;
power outage duration;
expected energy not supplied; and
cost of power interruption.

6. The method of claim 4, wherein the calculating the component importance value for each of one or more of the plurality of components takes into account the respective component's effect on one or more particular load feeders.

7. The method of claim 1, further comprising computing a maintenance cost for the substation, based on the computed substation reliability model.

8. The method of claim 7, further comprising selecting from a plurality of maintenance strategies, wherein computing the maintenance cost for the substation is further based on the selected maintenance strategy.

9. The method of claim 7, further comprising calculating a lifecycle operating cost for the substation, based on at least the computed maintenance cost.

10. The method of claim 1, further comprising:
identifying two or more technical modification plans for the substation, the technical modification plans each comprising a refurbishment, retrofit, and replacement, for one or more of the plurality of components;
recalculating reliability data for each component following the impact of the refurbishment, retrofit, and replacement action on their failure mode;
computing, for each of the two or more technical modification plans, a respective alternative substation reliability model, based on the respective technical modification plan and further based on at least the adjusted statistical reliability data; and
computing, for each of the two or more technical modification plans, a respective alternative lifecycle operating cost for the substation, based on the corresponding alternative substation reliability model.

11. The method of claim 10, wherein computing the alternative substation reliability models comprises adjusting reliability data for each of the replaced and/or refurbished components.
